(19) United States
(12) Patent Application Publication
(10) Pub. No.: US 2010/0277133 A1
(43) Pub. Date: Nov. 4, 2010

(54) POWER SUPPLYING SYSTEM AND METHOD THEREOF

(76) Inventor: SHIH-CHIEH KING, Xindian City (TW)

Correspondence Address: LIN & ASSOCIATES INTELLECTUAL PROPERTY, INC., P.O. BOX 2339, SARATOGA, CA, 95070-0339, US

(21) Appl. No.: 12/770,734

(22) Filed: Apr. 30, 2010

(30) Foreign Application Priority Data
May 1, 2009 (TW) 098114642

(51) Int. Cl. H02J 7/00

(52) U.S. Cl. 320/166

(57) ABSTRACT

A power supplying system and a method thereof are provided. The power supplying system includes a pulse generator module, a current conducting switch module, a current source, and a capacitor. According to the power supplying system of the present invention, it is not needed to enlarge the capacitor area of the capacitor, and the current source can be properly controlled for avoiding current leakage. Further, the power supplying system is adapted to control a pulse generator module to output a signal having a small pulse width so as to control a current conducting switch module, for further controlling a charging time required for achieving a desired output voltage value. Furthermore, the power supplying system and the method thereof are adapted for saving the IC processing cost and improving the circuit reliability.

### BACKGROUND OF THE INVENTION

1. Field of the Invention

The present invention relates generally to a power supplying system, and more particularly, to a power supplying system applicable in a power charging environment and a method thereof. According to the present invention, a charging time which is required for achieving a desired output voltage is adjusted by modulating a pulse width of a pulse signal outputted from a pulse generator module. In such a way, by simply modulating the pulse width of the pulse signal outputted from the pulse generator module, the power supplying system of the present invention is adapted for being applied in any desired power charging environment, without adjusting a capacitance, a current conducting switch module, or a current source.

2. The Prior Arts

Currently, with respect to a power supplying circuit adapted for a circuit board, e.g., a power supplier supplying an output voltage, a current source provides a constant current, e.g., in a μA magnitude, for charging a capacitor, e.g., in a pF magnitude, so that the obtained output voltage is in a magnitude of several volts, e.g., 1 volt.

If the constant current is represented as I, the capacitance of the capacitor is represented as C, a charging time of charging the capacitor is represented as T, and the obtained output voltage is represented as V, then, an equation therebetween can be defined as I×T=C×V. For example, assuming the constant current I is 1 μA, the capacitance C is 10 pF, and the obtained voltage V is 1 volt, then the charging time T=(10 pF×1 V/1 μA)=10 μS. However, some circuits may require a charging time in an ms magnitude, e.g., 1 ms. In this respect, the charging time of T=10 μS is too fast.

Therefore, when the obtained voltage V is desired to rise more slowly, e.g., the charging time is in an ms magnitude, the capacitance C of the capacitor is often increased, or alternatively the constant current I is decreased. However, in order to increase the capacitance C, the capacitor area should be increased, which increases manufacturing cost of the IC processing. When considering to decrease the constant current I, it is further restricted by the leakage current and cannot obtain a controllable value, so that the charging time is hard to be maintained at the ms magnitude. Therefore, conventionally, when the charging voltage is in a volt magnitude, e.g., 1 V, the circuit including the constant current I (e.g., in the μA magnitude) and the capacitance C (e.g., in the pF magnitude) is incapable of achieving the desired charging time T by an IC processing.

Accordingly, it is desired to provide a power supplying system adapted for a power charging environment and a method thereof When a capacitor of such a power supplying system is charged, the voltage obtained by the charging operation is in a volt magnitude and remains rising slowly. In accordance with the present invention, the charging time is in an ms magnitude, and the capacitor area is not enlarged. The charging current source is properly controlled so that a current leakage can be avoided. Therefore, the present invention is adapted for saving the IC processing cost and improving the reliability of the circuit.

### SUMMARY OF THE INVENTION

Accordingly, a primary objective of the present invention is to provide a power supplying system and a method thereof The power supplying system is applicable in a power charging environment. The power supplying system is adapted to control a pulse generator module to output a pulse signal having a small pulse width so as to control a current conducting switch module, for further controlling a charging time required for achieving a desired output voltage value.

Another objective of the present invention is to provide a power supplying system and a method thereof The power supplying system is applicable in a power charging environment. The power supplying system is not needed to be configured with a capacitor having an enlarged capacitor area, and is capable of properly controlling the current source, so that a current leakage can be avoided.

A further objective of the present invention is to provide a power supplying system and a method thereof The power supplying system is applicable in a power charging environment. The power supplying system and the method thereof are adapted for saving the IC processing cost and improving the circuit reliability.

A still further objective of the present invention is to provide a power supplying system and a method thereof The power supplying system is applicable in a power charging environment. According to the present invention, by simply modulating the pulse width of the pulse waves outputted from the pulse generator module, the power supplying system of the present invention is adapted for being applied in any desired power charging environment, without adjusting a capacitance, a current conducting switch module, or a current source.

For achieving the foregoing objectives and others, the present invention provides a power supplying system. The power supplying system includes a pulse generator module, a current conducting switch module, a current source, and a capacitor. The pulse generator module, the current conducting switch module, the current source, or the capacitor can be configured in an IC manner in accordance with the practical application.

The pulse generator module includes an input terminal receiving a square wave signal. The square wave signal for example can be generated by a fixed-cycle oscillation circuit. The pulse generator module converts the received square wave signal into a pulse signal having a small pulse width.

The current conducting switch module receives the pulse signal from the pulse generator module and is turned on to be in a conducting status by the received pulse signal. When the current conducting switch module does not receive such a pulse signal, it remains in a non-conducting status.

The current source is electrically connected with the current conducting switch module. When the current conducting switch module is in the conducting status, the current source provides a constant current for charging the capacitor electrically connected to the current conducting switch module for achieving an output voltage value desired by the power supplying system. When there is no pulse signal generated and transmitted to the current conducting switch module, the current conducting switch module remains in a non-conducting status, and the current source does not charge the capacitor.

According to the power supplying system of the present invention, it is not needed to enlarge the capacitor area of the capacitor, and the current source can be properly controlled for avoiding current leakage. Further, the power supplying system is adapted to control a pulse generator module to output a signal having a small pulse width so as to control a current conducting switch module, for further controlling a charging time required for achieving a desired output voltage value. Furthermore, the power supplying system and the method thereof are adapted for saving the IC processing cost and improving the circuit reliability.

The power supplying system of the present invention is adapted to control a pulse generator module to output a signal having a small pulse width so as to control a current conducting switch module, for further controlling a charging time required for achieving a desired output voltage value.

The present invention further provides a method of using the power supplying system for executing a power charging process. First, in accordance with the pulse width modulation principle, a pulse width of a pulse signal outputted by a pulse generator module is modulated for adjusting a charging time required for achieving a desired output voltage value. Specifically, according to the charging time required for achieving the desired output voltage value, the pulse signal outputted from the pulse generator module is modulated to have a small pulse width, to achieve the charging time required for achieving the desired output voltage value. When the pulse width of the pulse signal is decreased, the charging time increases, and when the pulse width of the pulse signal is increased, the charging time decreases.

Then, the pulse signal having a small pulse width is used for controlling the current conducting switch module to be in a conducting status or a non-conducting status. Specifically, the current conducting switch module receives the pulse signal having a small pulse width from the pulse generator module, and is turned on to be in a conducting status by the received pulse signal. When the current conducting switch module does not receive such a pulse signal, it remains in a non-conducting status.

Then, when the current conducting switch module is in conducting status, the current source supplies a constant current for charging a capacitor electrically connected to the current conducting switch module for achieving the output voltage value desired by the power supplying system during the required charging time.

In accordance with the power supplying system and the method thereof, by modulating the pulse width of the pulse waves outputted from the pulse generator module, the power supplying system of the present invention is adapted for achieving the charging time required for achieving the desired output voltage, without adjusting the capacitance, the current conducting switch module, or the current source.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating the architecture and the operation of the power supplying system according to an embodiment of the present invention;

FIG. 2 is a flow chart illustrating the process of using the power supplying system to executing the power charging operation according to an embodiment of the present invention;

FIG. 3 is a schematic diagram illustrating the power supplying system and the operation thereof according to an embodiment of the present invention;

FIG. 4 is a schematic diagram illustrating the power supplying system and the operation thereof according to another embodiment of the present invention; and

FIG. 5 is a flow chart illustrating the process of using the power supplying system of FIG. 4 to executing the power charging operation according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

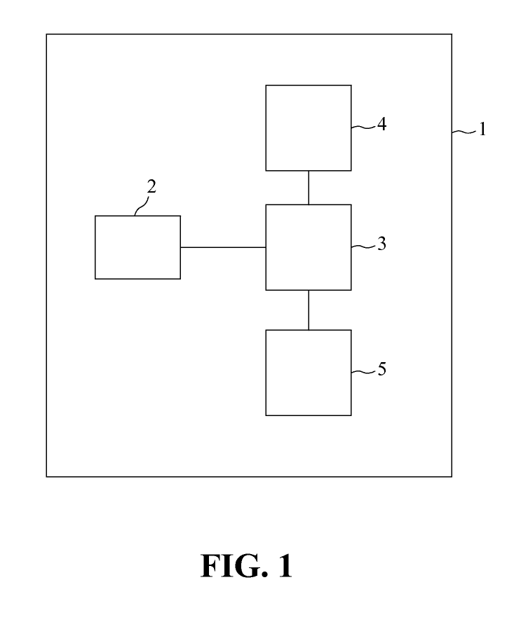

FIG. 1 is a schematic diagram illustrating the architecture and the operation of the power supplying system according to an embodiment of the present invention. Referring to FIG. 1, there is shown a power supplying system 1. The power supplying system 1 includes a pulse generator module 2, a current conducting switch module 3, a current source 4, and a capacitor 5. Preferably, the pulse generator module 2, and/or the current conducting switch module 3, and/or the current source 4, and/or the capacitor 5 are configured in an integrated circuit (IC) manner in accordance with the practical application.

The pulse generator module 2 includes an input terminal (not shown in the drawings) receiving a square wave signal (not shown in the drawings). The square wave signal for example can be generated by a fixed-cycle oscillation circuit. The pulse generator module 2 converts the received square wave signal into a pulse signal having a small pulse width (not shown in the drawings).

The current conducting switch module 3 receives the pulse signal from the pulse generator module 2 and is turned on to be in a conducting status by the received pulse signal. When the current conducting switch module 3 does not receive such a pulse signal, it remains in a non-conducting status.

The current source 4 is electrically connected with the current conducting switch module 3. When the current conducting switch module 3 is in the conducting status, the current source 4 provides a constant current (not shown in the drawings) for charging the capacitor 5 which is electrically connected to the current conducting switch module 3 for achieving an output voltage value desired by the power supplying system 1. When there is no pulse signal generated and transmitted to the current conducting switch module 3, the current conducting switch module 3 remains in a non-conducting status, and the current source 4 does not charge the capacitor 5.

According to the power supplying system 1 of the present invention, it is not needed to enlarge the capacitor area of the capacitor 5, and the current source 4 can be properly controlled to be not too small so as for avoiding a current leakage. Further, the power supplying system 1 is adapted to control a pulse generator module 2 to output a pulse signal having a small pulse width so as to control the current conducting switch module 3, for further controlling the charging time required for achieving the desired output voltage value. Furthermore, the power supplying system 1 and the method thereof are adapted for saving the IC processing cost and improving the circuit reliability.

The power supplying system 1 of the present invention is adapted to control the pulse generator module 2 to output a pulse signal having a small pulse width so as to control the current conducting switch module 3, for further controlling the charging time required for achieving a desired output voltage value.

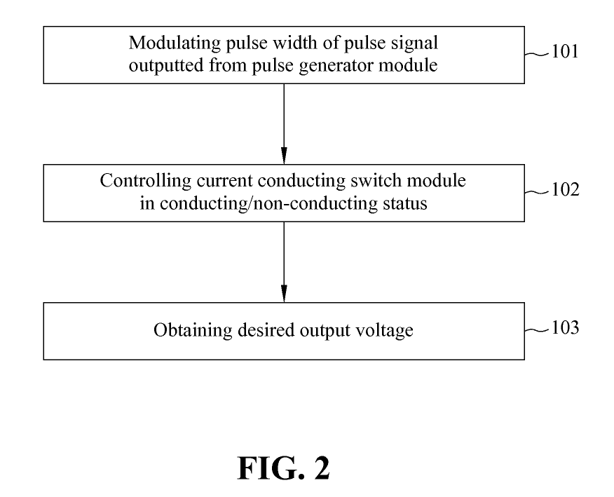

FIG. 2 is a flow chart illustrating the process of using the power supplying system to executing the power charging operation according to an embodiment of the present invention. Referring to FIG. 2, at step 101, in accordance with the pulse width modulation principle, a pulse width of a pulse signal outputted from the pulse generator module 2 is modulated for adjusting a charging time required for achieving a desired output voltage value. Specifically, during step 101, according to the charging time required for achieving the desired output voltage value, the pulse signal outputted from the pulse generator module 2 is modulated to have a small pulse width, to achieve the charging time required for achieving the desired output voltage value. When the pulse width of the pulse signal is decreased, the charging time increases, and when the pulse width of the pulse signal is increased, the charging time decreases.

And then the flow enters step 102. At step 102, the pulse signal having a small pulse width is used for controlling the current conducting switch module 3 to be in a conducting status or a non-conducting status. Specifically, during step 102, the current conducting switch module 3 receives the pulse signal having a small pulse width from the pulse generator module 2, and is turned on to be in a conducting status by the received pulse signal. When the current conducting switch module 3 does not receive such a pulse signal, it remains in a non-conducting status.

Then, the flow enters step 103. At step 103, when the current conducting switch module 3 is in conducting status, the current source 4 supplies a constant current for charging a capacitor 5 which is electrically connected to the current conducting switch module 3 for achieving the output voltage value desired by the power supplying system during the required charging time.

In accordance with the power supplying system 1 and the method thereof, by modulating the pulse width of the pulse waves outputted from the pulse generator module 2, the power supplying system 1 of the present invention is adapted for achieving the charging time required for achieving the desired output voltage, without adjusting the capacitor 5, the current conducting switch module 3, or the current source 4.

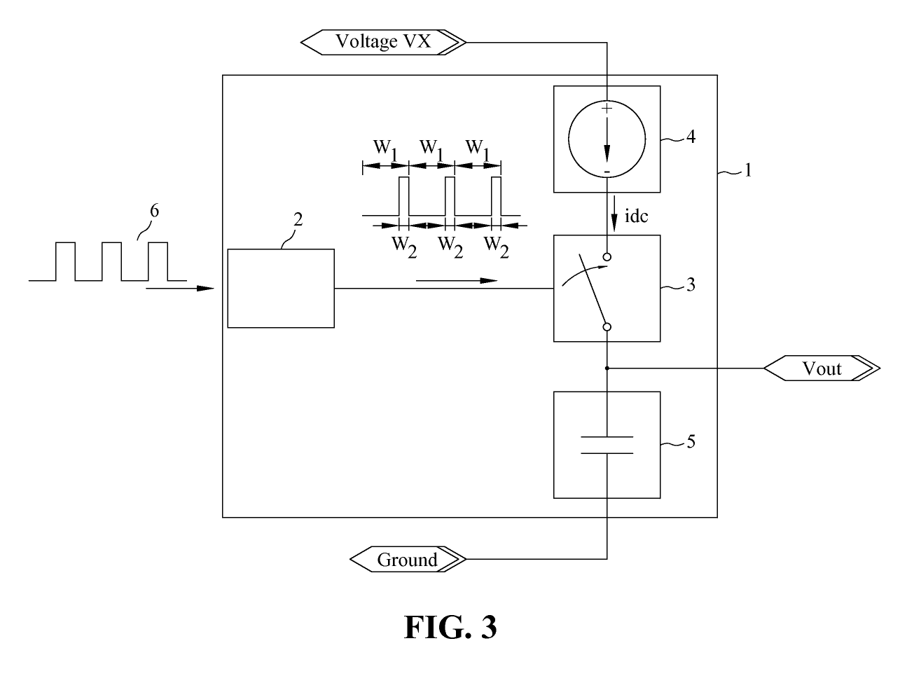

FIG. 3 is a schematic diagram illustrating the power supplying system and the operation thereof according to an embodiment of the present invention. Referring to FIG. 3, there is shown a power supplying system 1. The power supplying system 1 includes a pulse generator module 2, a current conducting switch module 3, a current source 4, and a capacitor 5. The power supplying system 1 is coupled between a voltage VX and a ground. The pulse generator module 2 is preferably a single pulse generator. The current conducting switch module 3 is preferably a current conducting switch. Preferably, the pulse generator module 2, and/or the current conducting switch module 3, and/or the current source 4, and/or the capacitor 5 are configured in an integrated circuit (IC) manner in accordance with the practical application.

A square wave signal 6, for example generated by a fixed-cycle oscillation circuit (not shown in the drawings), is inputted to the pulse generator module 2, i.e., the single pulse generator. The pulse generator module 2 then outputs a signal W1 having a small pulse width for controlling the conducting/non-conducting status of the current conducting switch module 3, i.e., the current conducting switch. The signal W1 has a pulse W2. The current conducting switch module 3 is turned on to be operated in a conducting status by the pulse W2 of the signal W1. The current source 4 provides a constant current idc for charging the capacitor 5, so as to achieve a desired output voltage Vout of the power supplying system 1. Where there is no pulse W2 of the signal W1 having a small pulse width received, the current conducting switch module 3 remains in the non-conducting status, and the current source does not charge the capacitor 5.

In accordance with the pulse width modulation principle, the pulse W2 of the signal W1 having a small pulse width outputted from the pulse generator module 2 is modulated for adjusting a charging time for charging the capacitor 5 required for achieving the desired output voltage Vout. When the pulse width of the pulse W2 of the signal W1 is decreased, the charging time for charging the capacitor 5 required for achieving the desired output voltage Vout increases, and when the pulse width of the pulse W2 of the signal W1 is increased, the charging time for charging the capacitor 5 required for achieving the desired output voltage Vout decreases. The power supplying system 1 outputs the signal W1 having a small pulse width from the pulse generator module 2, so as to control the current conducting switch module 3, so as to further control the charging time for charging the capacitor 5 required for achieving the desired output voltage Vout.

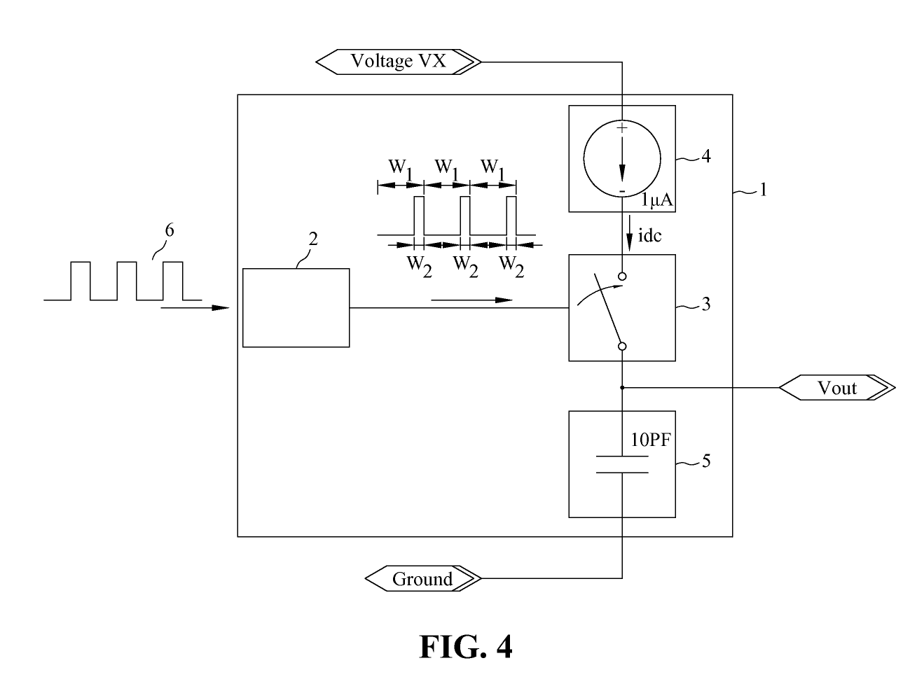

FIG. 4 is a schematic diagram illustrating the power supplying system and the operation thereof according to another embodiment of the present invention. Referring to FIG. 4, there is shown a power supplying system 1. The power supplying system 1 includes a pulse generator module 2, a current conducting switch module 3, a current source 4, and a capacitor 5. The power supplying system 1 is coupled between a voltage VX and a ground. The pulse generator module 2 is preferably a single pulse generator. The current conducting switch module 3 is preferably a current conducting switch. The current source 4 supplies a constant current idc. The constant current idc is 1 μA, and the capacitance of the capacitor 5 is 10 pF.

A square wave signal 6, for example generated by a fixed-cycle oscillation circuit (not shown in the drawings), is inputted to the pulse generator module 2, i.e., the single pulse generator. The pulse generator module 2 then outputs a signal W1 having a small pulse width for controlling the conducting/non-conducting status of the current conducting switch module 3, i.e., the current conducting switch. The signal W1 has a pulse W2, and a pulse width ratio between pulse widths of W2 and W1 is W2/W1=1%. The current conducting switch module 3 is turned on to be operated in a conducting status by the pulse W2 of the signal W1. The current source 4 provides a constant current idc for charging the capacitor 5, so as to achieve a desired output voltage Vout of the power supplying system 1. Where there is no pulse W2 of the signal W1 having a small pulse width received, the current conducting switch module 3 remains in the non-conducting status, and the current source does not charge the capacitor 5.

In accordance with the pulse width modulation principle, the 1 μA constant current idc is time-divisionally supplied from the current source to the 10 pF capacitor 5. Since the pulse width ratio W2/W1=1%, the pulse width is modulated to 1%. Therefore, assuming that the desired output voltage Vout=1 V, according to the equation I×T=C×V of the constant current I, the capacitance C, the charging time T, and the obtained output voltage V, and the pulse width modulation ratio which is known as 1%, the charging time of the capacitor 5 can be obtained as (10 pF×1 V/1 μA)/1%=10 μS×100=1000 μS. In such a way, the charging time is elongated as desired for slowly charging the capacitor 5.

In accordance to this embodiment, although it is exemplified that the constant current idc=1 μA, and the capacitance of the capacitor 5 is 10 pF, the constant current idc and the capacitance of the capacitor 5 can be adaptively modified to be any values. Further, although the pulse width ratio between W2 and W1 is exemplified as 1% for achieving a pulse modulation of 1%, it should be noted that the W2/W1 ratio could be set as any value smaller than 50%. With respect to other kinds of signals having small pulse width, the application could be learnt by referring to the foregoing discussion and is not to be iterated hereby.

The pulse W2 of the signal W1 having a small pulse width outputted from the pulse generator module 2 is modulated for adjusting a charging time for charging the capacitor 5 required for achieving the desired output voltage Vout.

When the pulse width of the pulse W2 of the signal W1 is decreased, the charging time for charging the capacitor 5 required for achieving the desired output voltage Vout increases, and when the pulse width of the pulse W2 of the signal W1 is increased, the charging time for charging the capacitor 5 required for achieving the desired output voltage Vout decreases. The power supplying system 1 outputs the signal W1 having a small pulse width from the pulse generator module 2, so as to control the current conducting switch module 3, so as to further control the charging time for charging the capacitor 5 required for achieving the desired output voltage Vout.

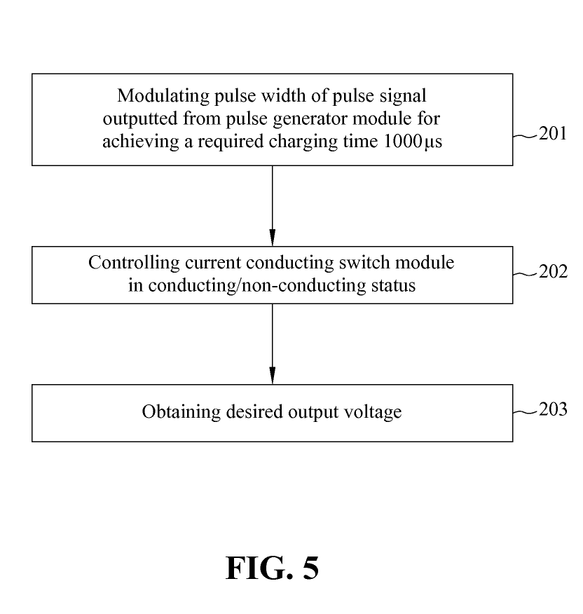

FIG. 5 is a flow chart illustrating the process of using the power supplying system of FIG. 4 to executing the power charging operation according to an embodiment of the present invention. Referring to FIG. 5, at step 201, in accordance with the pulse width modulation principle, a pulse width of a pulse signal outputted from the pulse generator module 2 is modulated for adjusting a charging time required for achieving a desired output voltage value. Specifically, assuming that the desired output voltage Vout=1 V, the desired charging time is 1000 μS, the constant current idc provided by the current source 4 is 1 μA, and the capacitance of the capacitor 5 is 10 pF, according to the equation I×T=C×V of the constant current I, the capacitance C, the charging time T, and the obtained output voltage V, it can be obtained that the pulse width modulation is [(10 pF×1 V/1 μA)/1000 μS]=0.01=1%. As such a pulse width ratio between W2 and W1 is 1%, i.e., W2/W1=1%.

And then the flow enters step 202. At step 202, the pulse generator module 2 outputs a signal W1 having a small pulse width for controlling the conducting/non-conducting status of the current conducting switch module 3, i.e., the current conducting switch. The signal W1 has a pulse W2, and a pulse width ratio between W2 and W1 is W2/W1=1%. The current conducting switch module 3 is turned on to be operated in a conducting status by the pulse W2 of the signal W1. When the current conducting switch module 3 does not receive the pulse W2 of the signal W, it remains in a non-conducting status.

Then, the flow enters step 203. At step 203, the current source 4 provides a constant current idc for charging the capacitor 5 which is electrically connected to the current conducting switch module 3, so as to achieve a desired output voltage Vout of the power supplying system 1. The current source 4 charges the capacitor 5 for the charging time, i.e., 1000 μS to obtain the desired output voltage Vout=1 V.

The pulse W2 of the signal W1 having a small pulse width outputted from the pulse generator module 2 is modulated for adjusting a charging time for charging the capacitor 5 required for achieving the desired output voltage Vout. When the pulse width of the pulse W2 of the signal W1 is decreased, the charging time for charging the capacitor 5 required for achieving the desired output voltage Vout increases, and when the pulse width of the pulse W2 of the signal W1 is increased, the charging time for charging the capacitor 5 required for achieving the desired output voltage Vout decreases. The power supplying system 1 outputs the signal W1 having a small pulse width from the pulse generator module 2 (i.e., the single pulse generator), so as to control the current conducting switch module 3 (i.e., the current conducting switch), so as to further control the charging time for charging the capacitor 5 required for achieving the desired output voltage Vout.

In summary, the present invention provides a power supplying system and a method thereof, adapted for being applied in a charging environment. According to the power supplying system of the present invention, it is not needed to enlarge the capacitor area of the capacitor, and the current source can be properly controlled for avoiding current leakage. Further, the power supplying system is adapted to control a pulse generator module to output a pulse signal having a small pulse width so as to control a current conducting switch module, for further controlling a charging time required for achieving a desired output voltage value. Furthermore, the power supplying system and the method thereof are adapted for saving the IC processing cost and improving the circuit reliability. In accordance with the power supplying system and the method thereof, by modulating the pulse width of the pulse waves outputted from the pulse generator module, the power supplying system of the present invention is adapted for achieving the charging time required for achieving the desired output voltage, without adjusting the capacitance, the current conducting switch module, or the current source.

Briefly, the present invention has the following advantages:

1. The power supplying system is adapted to control a pulse generator module to output a pulse signal having a small pulse width so as to control a current conducting switch module, for further controlling a charging time required for achieving a desired output voltage value.

2. The power supplying system is not needed to be configured with a capacitor having an enlarged capacitor area, and is capable of properly controlling the current source, so that a current leakage can be avoided.

3. The power supplying system and the method thereof are adapted for saving the IC processing cost and improving the circuit reliability.

4. By simply modulating the pulse width of the pulse waves outputted from the pulse generator module, the power supplying system of the present invention is adapted for being applied in any desired power charging environment, without adjusting the capacitance, the current conducting switch module, or the current source.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A power supplying method, adapted for charging a capacitor for a charging time to achieve a desired output voltage, comprising:
modulating a pulse of a signal having a small pulse width according to the charging time;
using the modulated pulse for controlling whether or not to charge the capacitor; and
charging the capacitor to achieve the desired output voltage in the charging time.

2. A power supplying method, adapted for charging a capacitor for a charging time to achieve a desired output voltage, comprising:
modulating a pulse of a signal outputted from a pulse generator module according to the charging time for achieving the charging time;
using the modulated pulse for controlling a conducting/non-conducting status of a current conducting switch module, wherein when receiving the modulated pulse, the current conducting switch is turned on to be in the conducting status, and when the current conducting switch does not receive the modulated pulse, the current conducting switch remains in the non-conducting status; and
when the current conducting switch is in the conducting status, a current source provides a constant current for charging the capacitor electrically coupled with the current conducting switch module to achieve the desired output voltage in the charging time.

3. The power supplying method as claimed in claim 2, wherein the charging time is in a millisecond (ms) magnitude.

4. The power supplying method as claimed in claim 2, wherein the pulse generator module is configured in an integrated circuit (IC) manner.

5. The power supplying method as claimed in claim 2, wherein the current conducting switch module is configured in an integrated circuit (IC) manner.

6. The power supplying method as claimed in claim 2, wherein the current source is configured in an integrated circuit (IC) manner.

7. The power supplying method as claimed in claim 2, wherein the capacitor is configured in an integrated circuit (IC) manner.

8. The power supplying method as claimed in claim 2, wherein the constant current provided by the current source is in a μA magnitude.

9. The power supplying method as claimed in claim 2, wherein the capacitor has a pF magnitude capacitance.

10. A power supplying system, adapted for being applied in a power charging environment, comprising:
a pulse generator module, receiving a square wave signal, and converting the received square wave signal into a signal having a small pulse width;
a current conducting switch module, adapted to be turned on for being operated in a conducting status by the signal received from the pulse generator module;
a current source, wherein when the current conducting switch module is in the conducting status, the current source provides a constant current; and
a capacitor, electrically connected to the current conducting switch module and adapted for being charged for a charging time by the constant current provided by the current source for achieving a desired output voltage of the power supplying system;
wherein the charging time can be adjusted by modulating the signal having a small pulse width.

11. A power supplying system, adapted for being applied in a power charging environment, comprising:
a pulse generator module, receiving a square wave signal generated by a fixed-cycle oscillation circuit, and converting the received square wave signal into a signal having a small pulse width;
a current conducting switch module, adapted to be controlled by a pulse of the signal received from the pulse generator module for time-divisionally conducting;
a current source, wherein when the current conducting switch module is in a conducting status, the current source provides a constant current; and
a capacitor, electrically connected to the current conducting switch module, and adapted for being charged for a charging time by the constant current provided by the current source for achieving a desired output voltage of the power supplying system;
wherein the charging time can be adjusted by modulating the pulse of the signal having a small pulse width.

12. The power supplying system as claimed in claim 11, being configured in an integrated circuit (IC) manner.

13. The power supplying system as claimed in claim 11, wherein the pulse generator module is configured in an integrated circuit (IC) manner.

14. The power supplying system as claimed in claim 11, wherein the current conducting switch module is configured in an integrated circuit (IC) manner.

15. The power supplying system as claimed in claim 11, wherein the current source is configured in an integrated circuit (IC) manner.

16. The power supplying system as claimed in claim 11, wherein the capacitor is configured in an integrated circuit (IC) manner.

17. The power supplying system as claimed in claim 11, wherein the constant current provided by the current source is in a μA magnitude.

18. The power supplying system as claimed in claim 11, wherein the capacitor has a pF magnitude capacitance.

19. The power supplying system as claimed in claim 11, wherein the charging time is in a millisecond (ms) magnitude.

20. The power supplying system as claimed in claim 11, wherein a pulse width of the pulse is smaller than 50% of a pulse width of the signal.
